(19) United States
(12) Patent Application Publication
(10) Pub. No.: US 2015/0326892 A1
(43) Pub. Date: Nov. 12, 2015

(54) SYSTEM AND METHOD FOR IDENTIFYING TARGET AREAS IN A REAL-TIME VIDEO STREAM

(71) Applicants: Sony Corporation, Tokyo (JP); Sony Network Entertainment International LLC, Los Angeles, CA (US)

(72) Inventors: CHARLES McCOY, Coronado, CA (US); CLAY FISHER, San Diego, CA (US); TRUE XIONG, San Diego, CA (US)

(73) Assignees: Sony Corporation, Tokyo (JP); Sony Network Entertainment International LLC, Los Angeles, CA (US)

(21) Appl. No.: 14/273,713

(22) Filed: May 9, 2014

(51) Int. Cl. H04N 21/234; H04N 21/2668; H04N 21/81; H04L 29/08; H04L 29/06

(52) U.S. Cl. CPC H04N 21/23424; H04L 67/10; H04L 65/60; H04N 21/23418; H04N 21/812; H04N 21/8146; H04N 21/2668

(57) ABSTRACT

Various aspects of a system and a method for identifying one or more target areas on an object in a real-time video stream may comprise a server. The server identifies one or more target areas on an object in a real-time video stream based on one or more pre-defined machine recognizable identifiers associated with the object. The server dynamically replaces, in real-time, a first content of the identified one or more target areas with a second content specified by the server.

### FIELD

Various embodiments of the disclosure relate to processing a real-time video stream. More specifically, various embodiments of the disclosure relate to a system and method for identifying target areas in a real-time video stream.

### BACKGROUND

Advertisements enable companies and/or service providers to inform the public about their products and/or services. One example of advertising products and/or services may occur at a sporting event. Advertisements may be displayed at various locations of a sporting event by use of banners, billboards, and/or other means. For example, advertisements may be displayed on billboards placed at a boundary of a playing field, and/or on the clothing of players. Advertisements may also be displayed on objects used in sporting events, such as a soccer ball, a basketball, and/or the like.

Advertisements at a sporting event may be displayed to viewers present at the sporting event and/or to viewers watching a broadcast of the sporting event. However, advertisements displayed to viewers are static. The same advertisements are displayed to all viewers of the broadcast of the sporting event, regardless of their geographic location and/or availability of the advertised product at their geographic location.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and a method for identifying target areas in a real-time video stream is described substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating an exemplary network environment, in accordance with an embodiment of the disclosure.

FIG. 2 is a block diagram of an exemplary server for processing a real-time video stream, in accordance with an embodiment of the disclosure.

FIG. 3 illustrates an example of an object comprising one or more machine recognizable identifiers, in accordance with an embodiment of the disclosure.

FIGS. 4A, 4B, 4C and 4D illustrate an example of various aspects of a real-time video stream, in accordance with an embodiment of the disclosure.

FIG. 5 is a block diagram of an exemplary user device for processing a real-time video stream, in accordance with an embodiment of the disclosure.

FIG. 6 is a flow chart illustrating exemplary steps for identifying target areas in a real-time video stream, in accordance with an embodiment of the disclosure.

### DETAILED DESCRIPTION

Various implementations may be found in a system and/or a method for identifying target areas in a real-time video stream. Exemplary aspects of a method for identifying target areas in a real-time video stream may include a server. The server may identify one or more target areas on an object in a real-time video stream based on one or more pre-defined machine recognizable identifiers associated with the object. The server may replace, in real-time, a first content of the identified one or more target areas with a second content.

The server may process the real-time video stream. The server may recognize the one or more machine recognizable identifiers based on the processing. The server may broadcast the real-time video stream with the first content being replaced by the second content. The server may determine a shape and/or an orientation of the one or more target areas. The server may modify the second content based on the determined shape and/or the determined orientation.

Further, the server may select the second content based on one or more parameters associated with the real-time video stream. The one or more parameters may comprise geographic location at which the real-time video stream is to be broadcast or language used by one or more users viewing the real-time video stream.

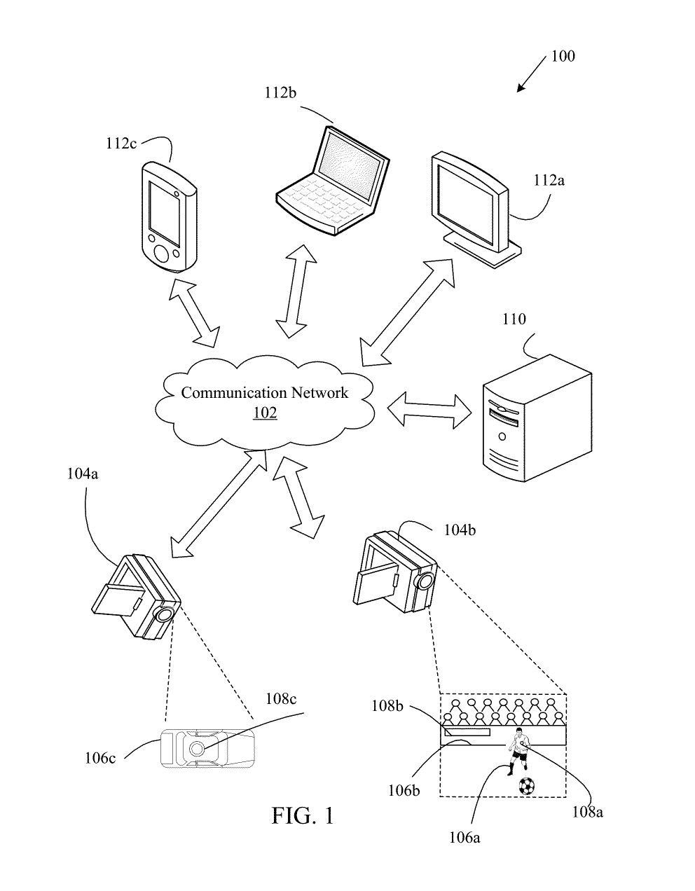

FIG. 1 is a block diagram illustrating an exemplary network environment, in accordance with an embodiment of the disclosure. With reference to FIG. 1, there is shown a network environment 100. The network environment 100 may comprise a communication network 102 and one or more cameras, such as a first camera 104a and a second camera 104b (collectively referred to as cameras 104). The cameras 104 may capture images and/or videos of one or more objects, such as a first object 106a, a second object 106b, and a third object 106c (collectively referred to as objects 106). Although FIG. 1 illustrates three objects, the disclosure may not be so limited and the network environment 100 may include any number of objects, without limiting the scope of the disclosure.

Each of the objects 106 may include one or more machine recognizable identifiers. For example, the first object 106a may include a first machine recognizable identifier 108a. Similarly, the second object 106b may include a second machine recognizable identifier 108b, and the third object 106c may include a third machine recognizable identifier 108c. The first machine recognizable identifier 108a, the second machine recognizable identifier 108b, and the third machine recognizable identifier 108c will hereinafter be collectively referred to as machine recognizable identifiers 108. Although FIG. 1 illustrates one machine recognizable identifier on each of the objects 106, the disclosure may not be so limited. Each of the objects 106 may include any number of machine recognizable identifiers, without limiting the scope of the disclosure.

The network environment 100 may further comprise a server 110 and one or more user devices, such as a first user device 112a, a second user device 112b and a third user device 112c (collectively referred to as user devices 112). Although FIG. 1 illustrates three user devices, the disclosure may not be so limited and the network environment 100 may include any number of user devices, without limiting the scope of the disclosure.

The network environment 100 may be operable to broadcast images and/or videos of an event. Examples of such an event may include, but are not limited to, a sporting event, such as a soccer match, a basketball match, and/or a car racing event. Notwithstanding, the disclosure may not be so limited and the network environment 100 may be associated with any event, other than a sporting event, without limiting the scope of the disclosure.

The network environment 100 may broadcast real-time images of an event to the user devices 112. The network environment 100 may further broadcast real-time video streams of an event to the user devices 112. A real-time video stream may be transmitted from an event venue to the user devices 112, via the communication network 102.

The communication network 102 may comprise a medium through which the cameras 104, the server 110, and the user devices 112 may be operable to communicate with each other. Examples of the communication network 102 may include, but are not limited to, the Internet, television broadcast network, satellite transmission, a Wireless Local Area Network (WLAN), a Local Area Network (LAN), a telephone line (POTS), a Metropolitan Area Network (MAN), a Bluetooth network, a Wireless Fidelity (Wi-Fi) network, and/or a ZigBee network. Various devices in the network environment 100 may be operable to connect to the communication network 102, in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The cameras 104 may be electronic devices capable of capturing and/or processing an image and/or a video. The cameras 104 may comprise suitable logic, circuitry, interfaces, and/or code that may be operable to capture and/or process an image and/or a video.

In an embodiment, the cameras 104 may be installed at the event venue to capture images and/or videos of the event. For example, the first camera 104a may be installed in a stadium, such that the first camera 104a may be capable of capturing images and/or videos of activities happening on a play field. In another example, the second camera 104b may be installed along a car race track, such that the second camera 104b may be operable to capture images and/or video of cars participating in the race.

In an embodiment, the cameras 104 may be pan-tilt-zoom (PTZ) cameras. The pan, tilt, and/or zoom of the cameras 104 may be controlled based on positions of the objects 106, such as players and cars, at the event venue.

In an embodiment, the cameras 104 may be operable to communicate with the server 110, via the communication network 102. The cameras 104 may be operable to receive one or more signals from the server 110. The cameras 104 may be operable to adjust the pan, tilt, and/or zoom based on the one more signals received from the server 110. The cameras 104 may be operable to transmit one or more signals to the server 110. In an embodiment, the cameras 104 may be operable to transmit captured images and/or videos of an event to the server 110. In an embodiment, the images and/or videos captured by the cameras 104 may include the objects 106 and the machine recognizable identifiers 108.

The objects 106 may correspond to any living and/or non-living thing that may be present at an event venue. The objects 106 may correspond to people, articles (such as a ball used in a sporting event), a vehicle, and/or a physical location at an event venue.

In an embodiment, the first object 106a may correspond to clothing worn by a player in a sporting event. For example, the first object 106a may be a jersey of a player playing in a soccer match. The second object 106b may correspond to a billboard placed at the event venue. For example, the second object 106b may correspond to a billboard placed along boundary of a soccer field. The third object 106c may correspond to a car participating in a car racing event. Notwithstanding, the disclosure may not be so limited and any other living and/or non-living thing may correspond to the objects 106 without limiting the scope of the disclosure.

In an embodiment, the objects 106 may be associated with the machine recognizable identifiers 108. Examples of the machine recognizable identifiers 108 may include, but are not limited to, a Quick Response (QR) code, a bar code, a pre-defined shape, a pre-defined pattern, and/or a pre-defined color.

The machine recognizable identifiers 108 on the objects 106 are pre-defined. In an embodiment, the machine recognizable identifiers 108 may be printed on the objects 106. In an embodiment, the machine recognizable identifiers 108 may be painted on the objects 106. For example, the third machine recognizable identifier 108c may be painted at a pre-defined location on a car participating in a car racing event (for example, the third object 106c). In an embodiment, the machine recognizable identifiers 108 may be embedded into the objects 106. For example, the first machine recognizable identifier 108a may be woven into fabric of clothing of a player at a pre-defined location. In an embodiment, the machine recognizable identifiers 108 may be attached to the objects 106.

In an embodiment, the machine recognizable identifiers 108 may be located at one or more pre-defined portions of the objects 106. For example, a QR code may be printed at a pre-defined location, such as on pocket, of clothing worn by a player. In an embodiment, the machine recognizable identifiers 108 may correspond to a pre-defined characteristic of the objects 106. For example, the color of an object may be a machine recognizable identifier.

In an embodiment, the machine recognizable identifiers 108 may be visible to viewers associated with an event. Viewers associated with an event may include viewers present at an event and/or viewers watching broadcast of an event. In an embodiment, the machine recognizable identifiers 108 may be advertisements, logos, and/or other images that may be visible to the viewers associated with an event.

In an embodiment, the machine recognizable identifiers 108 may not be visible to the viewers associated with an event. In an embodiment, one or more portions of the objects 106 that have the machine recognizable identifiers 108 may appear blank to the viewers associated with an event. In an embodiment, any content may be superimposed on one or more portions that have the machine recognizable identifiers. In such a case, the one or more portions would not appear blank to the viewers associated with an event. Examples of such content may include, but are not limited to, an image, a logo, an advertisement, a player name, a player number, and the like.

In an embodiment, each of the machine recognizable identifiers 108 may be associated with one or more target areas on the objects 106. A target area may correspond to an area on the objects 106, whose content may be replaced by the server 110. In an embodiment, the machine recognizable identifiers 108 may specify one or more target areas on the objects 106. In an embodiment, one or more portions of the objects 106 may correspond to one or more target areas. In an embodiment, an entire object may correspond to a target area. In an embodiment, one or more target areas on the objects 106 may be same as one or more portions of the objects 106 that have the machine recognizable identifiers 108. In an embodiment, one or more target areas on the objects 106 may be different from one or more portions of the objects 106 that have the machine recognizable identifiers 108.

In an embodiment, the machine recognizable identifiers 108 may occupy the entire target area. In an embodiment, the machine recognizable identifiers 108 may occupy only a portion of a target area. In an embodiment, the machine readable identifiers 108 may be completely located inside a target area. This may happen when the size of the machine recognizable identifiers 108 is smaller than the size of a target area. In an embodiment, the machine recognizable identifiers 108 may extend outside of a target area such that a portion of the machine recognizable identifiers 108 may be located outside the target area. This may happen when the size of the machine recognizable identifiers 108 is larger than the size of a target area. In an embodiment, the machine recognizable identifiers 108 may be entirely outside of a target area. For example, a frame drawn around a target area may act as a machine recognizable identifier. In such a case, when content of the target area is replaced, the frame may not be replaced. Content of the target area inside the frame may be replaced.

The server 110 may comprise suitable logic, circuitry, interfaces, and/or code that may be operable to broadcast real-time video stream of an event to the user devices 112. The server 110 may be operable to transmit one or more control signals to the cameras 104, to control an operation of the cameras 104. The server 110 may be operable to receive real-time images and/or real-time video streams from the cameras 104, via the communication network 102. The server 110 may be operable to process the received real-time images and/or real-time video streams to identify the machine recognizable identifiers 108 included in the received real-time images and/or real-time video streams. Based on the identified machine recognizable identifiers 108, the server 110 may be operable to determine one or more target areas on the objects 106 in the received real-time images and/or real-time video streams.

The server 110 may be operable to replace content within one or more target areas with other content. The server 110 may broadcast a real-time media stream to the user devices 112 with replaced content appearing within the one or more target areas.

In an embodiment, the server 110 may determine information associated with the objects 106, based on the identified machine recognizable identifiers 108. The server 110 may transmit information associated with the objects 106 to the user devices 112, via the communication network 102.

The user devices 112 may correspond to electronic devices capable of displaying a real-time media stream broadcast by the server 110. The user devices 112 may comprise suitable logic, circuitry, interfaces, and/or code that may be operable to display a real-time media stream broadcast by the server 110. The user devices 112 may communicate with the server 110 via the communication network 102. Examples of the user devices 112 may include, but are not limited to, a television, a smartphone a laptop, a computer, and the like.

In an embodiment, the first user device 112a may be a television. The second user device 112b may be a laptop. The third user device 112c may be a smartphone. Notwithstanding, the disclosure may not be so limited and any other electronic device capable of receiving a real-time video stream may correspond to the user devices 112 without limiting the scope of the disclosure.

In operation, the cameras 104 may be operable to capture real-time videos of an event. The captured real-time videos may include videos of the objects 106 and the machine recognizable identifiers 108. The cameras 104 may transmit the captured real-time video stream to the server 110. The server 110 may process the received real-time video stream to identify the machine recognizable identifiers 108. Based on the identified machine recognizable identifiers 108, the server 110 may determine one or more target areas on the objects 106 in the real-time video stream. The server 110 may dynamically replace, in real-time, an original content within the identified one or more target areas with a new content. The server 110 may transmit a real-time video stream to the user devices 112. In the real-time video stream broadcast by the server 110, the original content within one or more target areas may be replaced with a new content.

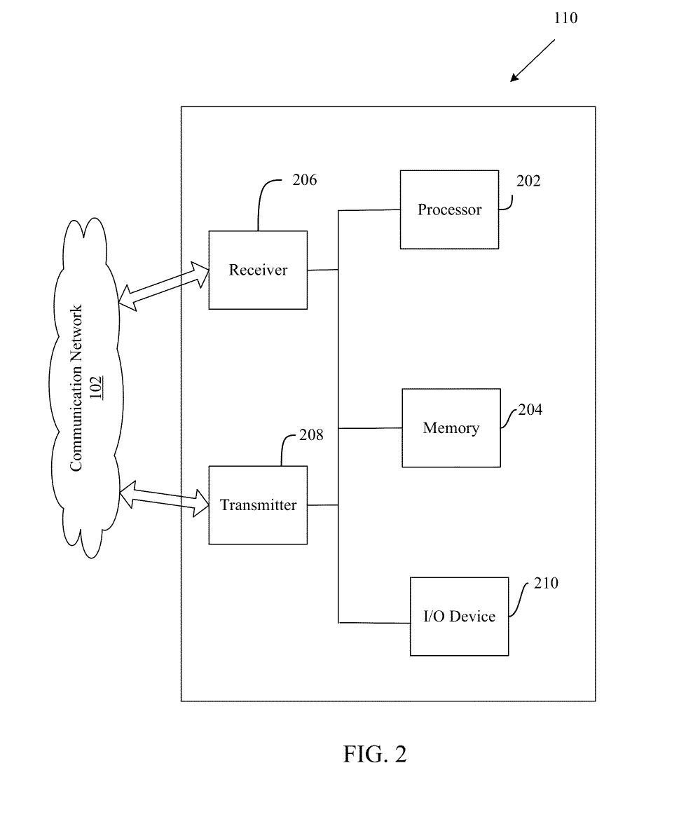

FIG. 2 is a block diagram of an exemplary server for processing a real-time video stream, in accordance with an embodiment of the disclosure. FIG. 2 is explained in conjunction with elements from FIG. 1. With reference to FIG. 2, there is shown the server 110. The server 110 may comprise one or more processors, such as a processor 202, a memory 204, a receiver 206, a transmitter 208, and an input/output (I/O) device 210.

The processor 202 may be communicatively coupled to the memory 204, and the I/O device 210. The receiver 206 and the transmitter 208 may be communicatively coupled to the processor 202, the memory 204, and the I/O device 210.

The processor 202 may comprise suitable logic, circuitry, and/or interfaces that may be operable to execute at least one code section stored in the memory 204. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The memory 204 may comprise suitable logic, circuitry, interfaces, and/or code that may be operable to store a machine code and/or a computer program having at least one code section executable by the processor 202. Examples of implementation of the memory 204 may include, but are not limited to, Random Access Memory (RAM), Read Only Memory (ROM), Hard Disk Drive (HDD), and/or a Secure Digital (SD) card. The memory 204 may be operable to store data, such as configuration settings of the cameras 104. The memory 204 may further be operable to store one or more parameters associated with a real-time video stream broadcast by the server 110. The one or more parameters may comprise geographic location at which a real-time video stream is to be broadcast. The one or more parameters may comprise the language used by one or more users who will view a real-time video stream being broadcast. The memory 204 may further be operable to store data associated with the user devices 112. Examples of such data associated with the user devices 112 may include, but are not limited to, geographic location of the user devices 112, one or more preferences of a user associated with the user devices 112, and/or any other information associated with the user devices 112.

The memory 204 may further store one or more images and/or video content captured by the cameras 104. The memory 204 may store one or more images and/or video contents in various standardized formats, such as Joint Photographic Experts Group (JPEG), Tagged Image File Format (TIFF), Graphics Interchange Format (GIF), Moving Picture Experts Group (MPEG-4), 3GP file format, and/or any other format. The memory 204 may further store one or more algorithms that process images and/or video streams. The memory 204 may further store content to be used in one or more target areas on the objects 106. Examples of such content may include, but are not limited to, a static image, an animated image, a video, an advertisement, a logo, a symbol, a number, and/or a letter. The memory 204 may further store other data.

The receiver 206 may comprise suitable logic, circuitry, interfaces, and/or code that may be operable to receive data and messages. The receiver 206 may receive data in accordance with various known communication protocols. In an embodiment, the receiver 206 may receive one or more signals transmitted by the cameras 104. In an embodiment, the receiver 206 may receive data from the cameras 104. Such data may include one or more images and/or real-time videos of an event captured by the cameras 104. In an embodiment, the receiver 206 may receive one or more signals transmitted by the user devices 112. The receiver 206 may implement known technologies for supporting wired or wireless communication between the server 110, and the user devices 112, and/or the cameras 104. In an embodiment, the receiver 206 may receive a request from the user devices 112, to provide a real-time video stream to the user devices 112.

The transmitter 208 may comprise suitable logic, circuitry, interfaces, and/or code that may be operable to transmit data and/or messages. The transmitter 208 may transmit data, in accordance with various known communication protocols. In an embodiment, the transmitter 208 may transmit one or more control signals to the cameras 104, to control an operation thereof. In an embodiment, the transmitter 208 may transmit a real-time video stream to the user devices 112.

The I/O device 210 may comprise various input and output devices that may be operably coupled to the processor 202. The I/O device 210 may comprise suitable logic, circuitry, interfaces, and/or code that may be operable to receive input from a user operating the cameras 104 and provide an output. Examples of input devices may include, but are not limited to, a keypad, a stylus, and/or a touch screen. Examples of output devices may include, but are not limited to, a display and/or a speaker.

In operation, the processor 202 may receive a real-time video stream from the cameras 104. The processor 202 may identify the machine recognizable identifiers 108, in the received real-time video stream. Based on the machine recognizable identifiers 108, the processor 202 may identify one or more target areas on the objects 106.

In an embodiment, the cameras 104 may capture one or more images and/or videos of the objects 106 present at an event venue. The cameras 104 may generate a real-time video stream of the event based on the captured one or more images and/or videos. The real-time video stream may include one or more images and/or videos of the objects 106 present at the event venue. The objects 106 may be associated with the machine recognizable identifiers 108. The real-time video stream may further include one or more images and/or videos of the machine recognizable identifiers 108. The cameras 104 may transmit the captured images and/or videos to the processor 202, via the communication network 102.

In an embodiment, the processor 202 may receive a real-time video stream of an event from the cameras 104. The processor 202 may store the received real-time video stream in the memory 204. The processor 202 may process the received real-time video stream to identify the machine recognizable identifiers 108 in the real time video stream. The processor 202 may process the received real-time video stream using various video processing algorithms known in the art. For example, the second machine recognizable identifier 108b may be a QR code printed on a billboard (such as the second object 106b). In such a case, the processor 202 may identify the second machine recognizable identifier 108b in a real-time video stream received from the cameras 104. In another example, the third machine recognizable identifier 108c may be a pre-defined color (such as red) painted on a car participating in a car race (such as the third object 106c). In such a case, the processor 202 may identify the third machine recognizable identifier 108c in a real-time video stream received from the cameras 104.

In an embodiment, the processor 202 may identify one or more target areas on the objects 106 in the real-time video stream based on the identified machine recognizable identifiers 108. For example, in a real-time video stream the processor 202 may identify the first machine recognizable identifier 108a associated with the first object 106a. The processor 202 may identify a target area on the first object 106a, which may be associated with the first machine recognizable identifier 108a.

In an embodiment, the processor 202 may determine the shape and/or the orientation of one or more target areas on the objects 106. In an embodiment, the shape and/or the orientation of the one or more target areas may be pre-defined by the machine recognizable identifiers 108. In an embodiment, the processor 202 may determine the shape and/or the orientation of one or more target areas based on a user input. For example, a user associated with the server 110 may define the shape and/or the orientation of the one or more target areas. Notwithstanding, the disclosure may not be so limited and any other technique that determine a shape and/or an orientation of one or more target areas may be used without limiting the scope of the disclosure.

In an embodiment, the processor 202 may dynamically replace, in real-time, a current content of the one or more target areas (referred to as a first content). The processor 202 may replace the first content with a new content (referred to as a second content) in real-time. Examples of the first content may include, but are not limited to, to a static image, an advertisement, a logo, a symbol, a color, a number, a letter and/or a blank region. Examples of the second content may include, but are not limited to, a static image, an animated image, a video, an advertisement, a logo, a symbol, a number, a letter and/or a color. For example, a machine recognizable identifier may be a pre-defined shape and/or color, such as a green color rectangle, printed on a car participating in a car racing event. The area covered by the rectangle may correspond to a target area. In such a case, the processor 202 may identify a green rectangle on the car in a real-time video stream. The processor 202 may replace content within the identified rectangle by another content, such as an image. As a result, an image may be displayed to broadcast viewers, rather than a blank green rectangle.

In an embodiment, the processor 202 may dynamically determine, in real-time, a second content to be used to replace a first content in a target area on an object. In an embodiment, the processor 202 may dynamically determine a second content for a target area based on a machine recognizable identifier associated with the target area. In an embodiment, a second content for a target area may be pre-defined by a machine recognizable identifier associated with the target area. For example, the first machine recognizable identifier 108a may specify an advertisement to be used for a target area associated with the first machine recognizable identifier 108a. In such a case, the processor 202 may select the specified advertisement for the target area associated with the first machine recognizable identifier 108a.

In an embodiment, the processor 202 may select a second content based on one or more parameters associated with a real-time video stream. The one or more parameters may comprise the geographic location at which a real-time video stream is to be broadcast. The one or more parameters may further comprise the language used by one or more viewers of a real-time video stream broadcast. For example, the processor 202 may broadcast a real-time video stream of a sporting event occurring in London to viewers in New York. A first advertisement displayed on boundary of playing field may be associated with a product available in London. In such a case, the processor 202 may replace the first advertisement with a second advertisement. The processor 202 may select the second advertisement such that a product associated with the second advertisement is available in New York.

In an embodiment, the processor 202 may replace first content of each of one or more target areas on the objects 106 with a same second content. In an embodiment, the processor 202 may replace first content of each of one or more target areas on the objects 106 with a different second content. For example, the objects 106 may correspond to players of a team. The processor 202 may display a different advertisement in one or more target areas on clothing of each of the players.

In an embodiment, the processor 202 may determine a second content based on one or more parameters associated with the user devices 112. The one or more parameters associated with the user devices 112 may comprise configuration settings of each of the user devices 112, and/or preferences of one or more users associated with the user devices 112. Notwithstanding, the disclosure may not be so limited and the processor 202 may employ any other technique to determine a second content for a target area without limiting the scope of the disclosure.

In an embodiment, the processor 202 may modify one or more parameters associated with a second content based on the shape and/or the orientation of one or more target areas. Examples of one or more parameters associated with a second content may include, but are not limited to, size, format, color, and/or resolution. For example, the processor 202 may change the size of an image to be used, such that the image size fits the size of the target area. In another example, the processor 202 may modify the color of an image, such that the color of image is in contrast to color of an object on which the image is to be displayed.

In an embodiment, the processor 202 may modify a second content based on visibility of one or more of: the machine recognizable identifiers 108, the one or more target areas and/or a first content of the one or more target areas. In an embodiment, the machine recognizable identifiers 108 may be partially obscured in video frames in a real-time video stream received from the cameras 104. The processor 202 may process the received real-time video stream to identify the partially obscured machine recognizable identifiers 108 in the real-time video stream. In an embodiment, the one or more target areas and/or a first content associated with the one or more target areas may be partially obscured in video frames in a real-time video stream received from the cameras 104. In such a case, the processor 202 may determine portions of the one or more target areas and/or a first content associated with the one or more target areas that are obscured (hereinafter referred to as obscured portions). The processor 202 may further determine portions of one or more target areas and/or a first content associated with the one or more target areas that are visible (hereinafter referred to as visible portions). The processor 202 may not replace the first content of the obscured portions. The processor 202 may only replace first content of the visible portions, for example. The processor 202 may modify second content to be used to replace the first content of visible portions. In such a case, the processor 202 may modify the second content based on the shape and/or the orientation of visible portions. For example, the processor 202 may crop and/or reshape the second content corresponding to the obscured portions and may replace the second content in the visible portions. For example, a baseball player may walk in front of an advertisement on a fence that is being replaced by the processor 202. In such a case, the processor 202 may continue to recognize the original advertisement and replace it. The processor 202 may crop portions of a frame of a real-time video stream where the baseball player obscures the original advertisement. The processor 202 may replace the original advertisement with a new advertisement in portions of fence that are visible so that it looks like the baseball player is walking in front of the new advertisement.

In an embodiment, the processor 202 may retrieve a second content from a content server (different from the server 110), via the communication network 102. In another embodiment, the processor 202 may retrieve a second content from the memory 204 of the server 110.

In an embodiment, the processor 202 may determine information associated with the objects 106 based on the identified machine recognizable identifiers 108. The processor 202 may transmit information associated with the objects 106 to the user devices 112, via the communication network 102.

In an embodiment, the processor 202 may broadcast a real-time video stream to the user devices 112. The processor 202 may broadcast a real-time video stream to the user devices 112, via the communication network 102. In an embodiment, the processor 202 may broadcast a real-time video stream with a first content in one or more target areas replaced by a second content. In an embodiment, in each real-time video stream broadcast to each of the user devices 112, a different second content may replace the first content. In an embodiment, a second content selected for each of the user devices 112 may depend on geographic location of the corresponding user device. In an embodiment, a second content selected for each of the user devices 112 may depend on language of a user associated with the corresponding user device. In an embodiment, the processor 202 may determine the language of a user associated with a user device based on language setting of the user device. In an embodiment, the processor 202 may determine the language of a user associated with a user device based on the geographic location of the user device.

In an embodiment, the processor 202 may transmit different real-time video streams to each of the users 112. In such a case, the processor 202 may replace a first content of one or more target areas in each of the different real-time video streams with different second contents. As a result, the processor 202 may perform different substitutions in different real-time video streams. In an embodiment, the processor 202 may replace a first content of one or more target areas of a first real-time video stream and may not replace a first content of one or more target areas of a second real-time video stream. As a result, the processor 202 may generate two different real-time video streams for different users.

In an embodiment, the processor 202 may transmit a replay video stream of a real-time video stream to the users 112. In such a case, the processor 202 may generate a replay video stream which is different from the real-time video stream. The processor 202 may replace a first content in one or more target areas of the replay video stream with a second content. The processor 202 may replace a first content of one or more target areas of the replay video stream with a second content different from that is used to replace first content of the real-time video stream. In an embodiment, the processor 202 may replace a first content of one or more areas of a real-time video stream. The processor 202 may not replace a first content of one or more areas of the replay video stream that corresponds to the real-time video stream. In an embodiment, the processor 202 may not replace a first content of one or more areas of a real-time video stream. The processor 202 may replace a first content of one or more areas of the replay video stream that corresponds to the real-time video stream.

Each of the user devices 112 may receive a respective real-time video stream from the server 110. A second content of one or more target areas on the objects 106 may differ in real-time video streams received by each of the user devices 112. For example, a second content of a target area on the second object 106b, in a real-time video stream received by the first user device 112a, may be different from that in a real-time video stream received by the second user device 112b. Each of the user devices 112 may display a corresponding real-time video stream. In a real-time video stream displayed by a user device, a second content in a target area on an object may be displayed in such a way that the second content appears to be present on the object.

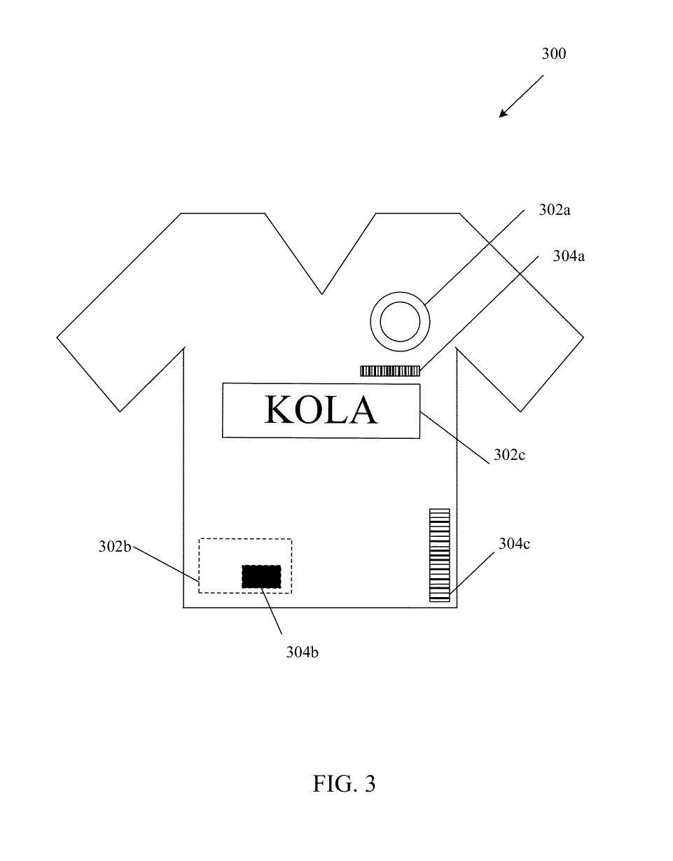

FIG. 3 illustrates an example of an object comprising one or more machine recognizable identifiers, in accordance with an embodiment of the disclosure. The example of FIG. 3 is explained in conjunction with the elements from FIG. 1 and FIG. 2. With reference to FIG. 3, there is shown a jersey 300 worn by a player. The jersey 300 may correspond to team uniform. The jersey 300 may comprise a first target area 302a, a second target area 302b, and a third target area 302c (collectively referred to as target areas 302). The jersey 300 may further comprise a first machine recognizable identifier 304a, a second machine recognizable identifier 304b, and a third machine recognizable identifier 304c (collectively referred to as machine recognizable identifiers 304). Although FIG. 3 shows three machine recognizable identifiers and three target areas on the jersey 300, the disclosure may not be so limited. Any number of machine recognizable identifiers and target areas may be present on the jersey 300 without limiting the scope of the disclosure.

The target areas 302 may correspond to those regions on the jersey 300 whose content may be replaced by the server 110, during broadcast of a real-time video stream. In an embodiment, positions of the target areas 302 may be pre-defined. In an embodiment, positions of the target areas 302 may be specified by the machine recognizable identifiers 304.

In an embodiment, each of the target areas 302 may be associated with content. In an embodiment, at the time of manufacturing the jersey 300, a first content may be associated with each of the target areas 302. For example, a first content associated with the first target area 302a may be an advertisement for a product. Similarly, a first content associated with the third target area 302c may be name of a lead sponsor of the team associated with the jersey 300.

In an embodiment, at the time of manufacturing the jersey 300, one or more of the target areas 302 may be left blank and no content may be associated with the one or more target areas. For example, the second target area 302b may be a blank region on the jersey 300.

In an embodiment, the machine recognizable identifiers 304 may specify a second content that may be used to replace a first content associated with each of the target areas 302. In an embodiment, the processor 202 may determine a second content that may be used to replace a first content associated with each of the target areas 302.

The machine recognizable identifiers 304 may be located at pre-defined positions on the jersey 300. In an embodiment, positions of the machine recognizable identifiers 304, on the jersey 300, may be defined at the time of manufacturing the jersey 300. In an embodiment, the machine recognizable identifiers 304 may specify positions of the target areas 302. The server 110 may identify one or more of the target areas 302, based on the machine recognizable identifiers 304.

In an embodiment, the machine recognizable identifiers 304 may specify a second content that may be used to replace a first content associated with each of the target areas 302. In an embodiment, the machine recognizable identifiers 304 may provide information related to a player associated with the jersey 300. Examples of such information may include, but are not limited to, name of the player, team associated with the player, various game statistics associated with the player, and/or profile of the player.

The first machine recognizable identifier 304a may correspond to a QR code. In an embodiment, at the time of manufacturing the jersey 300, a QR code may be printed on the jersey 300 at a pre-defined location. In an embodiment, at the time of manufacturing the jersey 300, a QR code may be woven into the fabric of the jersey 300 at a pre-defined location on the jersey 300. In an embodiment, the first machine recognizable identifier 304a may be associated with the first target area 302a. In an embodiment, the first machine recognizable identifier 304a may specify the position of the first target area 302a. In an embodiment, the first machine recognizable identifier 304a may further specify a second content that may be used to replace a first content associated with the first target area 302a.

The second machine recognizable identifier 304b may correspond to a pre-defined color on the jersey 300. In an embodiment, at the time of manufacturing the jersey 300, one or more regions on the jersey 300 may include a pre-defined color. The pre-defined color may either be applied to the one or more regions or the fabric itself may be of the pre-defined color. In an embodiment, the second machine recognizable identifier 304b may be associated with the second target area 302b. In an embodiment, the second machine recognizable identifier 304b may specify position of the second target area 302b. In an embodiment, the second machine recognizable identifier 304b may further specify a second content that may be used to replace a first content associated with the second target area 302b.

The third machine recognizable identifier 304c may correspond to a QR code similar to the QR code associated with the first machine recognizable identifier 304a. The third machine recognizable identifier 304c may be associated with the third target area 302c. In an embodiment, the third machine recognizable identifier 304c may specify the position of the third target area 302c. In an embodiment, the first machine recognizable identifier 304a may further specify a second content that may replace a first content associated with the third target area 302c. In an embodiment, the third machine recognizable identifier 304c may provide information related to a player associated with the jersey 300.

During a match, a player may wear the jersey 300. When a player wearing the jersey 300 is in the field-of-view of the cameras 104, the cameras 104 may capture an image and/or video of the jersey 300. The cameras 104 may transmit a real-time video stream of the jersey 300 to the server 110.

The server 110 may identify the machine recognizable identifiers 304 on the jersey 300 in the real-time video stream. In an embodiment, the server 110 may identify the first machine recognizable identifier 304a. The server 110 may determine a target area based on the first machine recognizable identifier 304a. In an embodiment, the server 110 may determine information associated with the first machine recognizable identifier 304a. The information associated with the first machine recognizable identifier 304a may define the first target area 302a. The server 110 may replace a first content of the first target area 302a with a second content in the real-time video stream.

Similarly, the server 110 may identify the second machine recognizable identifier 304b, and the third machine recognizable identifier 304c in the real-time video stream. The server 110 may define the second target area 302b, and the third target area 302c to be target areas associated with the second machine recognizable identifier 304b and the third machine recognizable identifier 304c, respectively. The server 110 may replace a first content of each of the second target area 302b, and the third target area 302c, with a different second content.

The server 110 may transmit the real-time video stream to the user devices 112 with a different second content in each of the first target area 302a, the second target area 302b, and the third target area 302c.

In an embodiment, the entire jersey 300 may be of a pre-defined color. For example, jerseys worn by players of different teams may be of different colors. In such a case, the color of the jersey 300 may correspond to a machine recognizable identifier. The processor 202 may recognize jerseys of different colors in a real-time video stream. The processor 202 may replace jerseys of different color with different content.

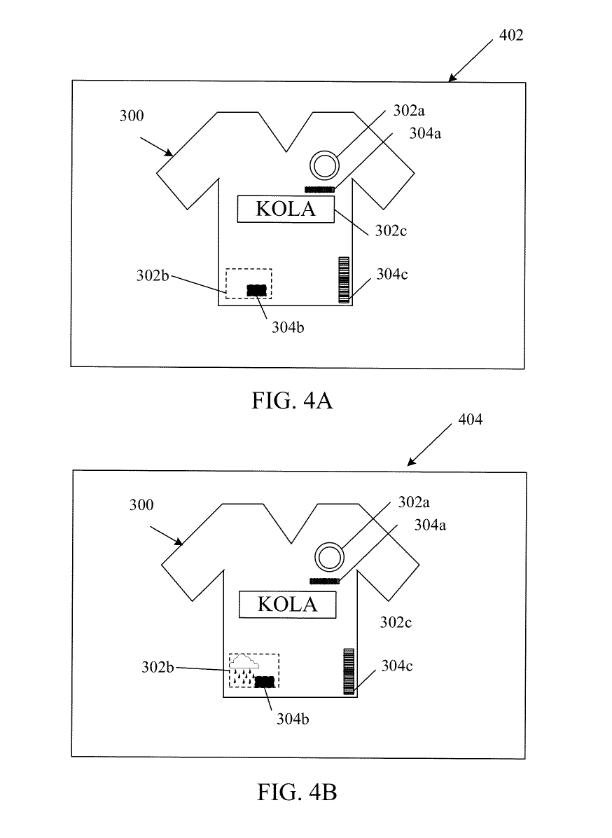

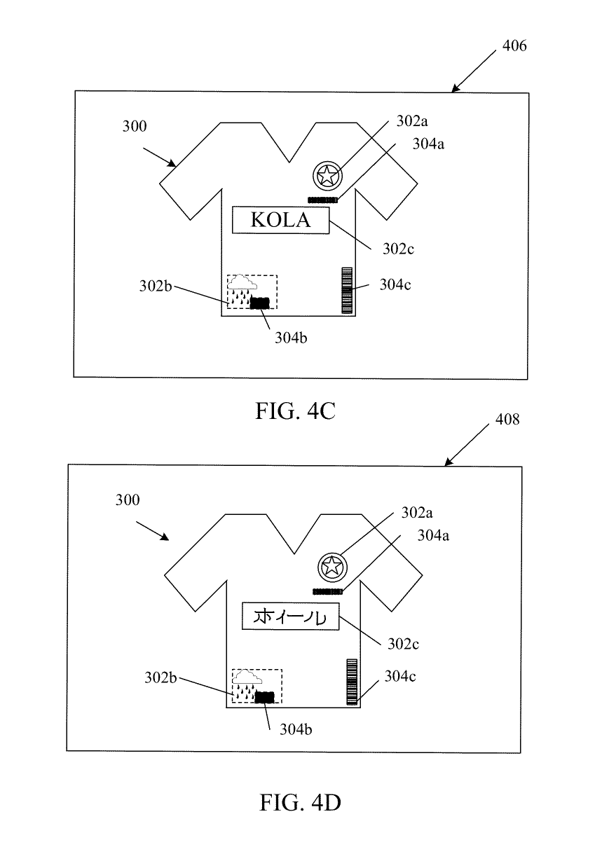

FIGS. 4A, 4B, 4C and 4D illustrate an example of various aspects of a real-time video stream, in accordance with an embodiment of the disclosure. The example of FIGS. 4A, 4B, 4C and 4D is explained in conjunction with the elements from FIG. 1, FIG. 2 and FIG. 3. For the explanation of FIGS. 4A, 4B, 4C and 4D, the user devices 112 are considered to be located at different geographic locations. For example, the first user device 112a may be located at New York. The second user device 112b may be located at London. The third user device 112c may be located at Tokyo. Notwithstanding, the disclosure may not be limited and the user devices 112 may be located at any geographic location without limiting the scope of the disclosure.

With reference to FIG. 4A, there is shown a first real-time video stream 402, captured by the cameras 104. The first real-time video stream 402 includes an image of the jersey 300 worn by a player. In the first real-time video stream 402, each of the target areas 302 has a first content associated with them. In an embodiment, a first content associated with the first target area 302a may be a logo of a company manufacturing a first product available in New York. The second target area 302b may be a blank region on the jersey 300, with no associated content. In an embodiment, the second target area 302b may include a pre-defined color. Further, a first content associated with the third target area 302c may be name of a sponsor written in English.

The server 110 may replace a first content of one or more of the target areas 302 in the first real-time video stream 402 with a second content. In an embodiment, the server 110 may select a second content based on the geographic location of a user device to which the first real-time video stream 402 is to be broadcast. In an embodiment, the server 110 may select second content based on a language associated with a user device to which the first real-time video stream 402 is to be broadcast. In an embodiment, the server 110 may select a second content for a target area based on information provided by a machine readable identifier associated with the target area. The server 110 may broadcast a real-time video stream with a second content in one or more target areas to the user devices 112.

With reference to FIG. 4B, there is shown a second real-time video stream 404, which may be broadcast to the first user device 112a by the server 110. The second real-time video stream 404 includes an image in the second target area 302b, as against the blank second target area 302b, in the first real-time video stream 402. The first content of the second target area 302b has been replaced by the server 110 in the second real-time video stream 404, which may be broadcast to the first user device 112a.

With reference to FIG. 4C, there is shown a third real-time video stream 406, which may be broadcast to the second user device 112b by the server 110. The third real-time video stream 406 includes an image in the second target area 302b, against the blank second target area 302b in the first real-time video stream 402. Further, the third real-time video stream 406 includes a new logo in the first target area 302a, against the logo associated with the first product available in New York in the first real-time video stream 402. The new logo may be associated with a second product available in London. The server 110 may select the new logo based on availability of a product at the geographic location of the second user device 112b.

With reference to FIG. 4D, there is shown a fourth real-time video stream 408, which may be broadcast to the third user device 112c by the server 110. The fourth real-time video stream 408 includes an image in the second target area 302b, against the blank second target area 302b in the first real-time video stream 402. Further, the fourth real-time video stream 408 includes a new logo in the first target area 302a, against the logo associated with the first product available in New York in the first real-time video stream 402. The new logo may be associated with a third product available in Tokyo. The server 110 may select the new logo based on the availability of a product at the geographic location of the third user device 112c. Further, the fourth real-time video stream 408 includes name of the sponsor written in Japanese in the second target area 302b, against the name of the sponsor written in English in the first real-time video stream 402. The server 110 may select the language based on the language of a user associated with the third user device 112c. Notwithstanding, the disclosure may not be so limited and the server 110 may select any content for use in a target area on any object in a real-time video stream without limiting the scope of the disclosure.

Although the disclosure has been described with the server 110 processing a real-time video stream to identify one or more machine recognizable identifiers, the disclosure may not be so limited. In an embodiment, a user device may process a real-time video stream received from the server 110 to identify one or more machine recognizable identifiers.

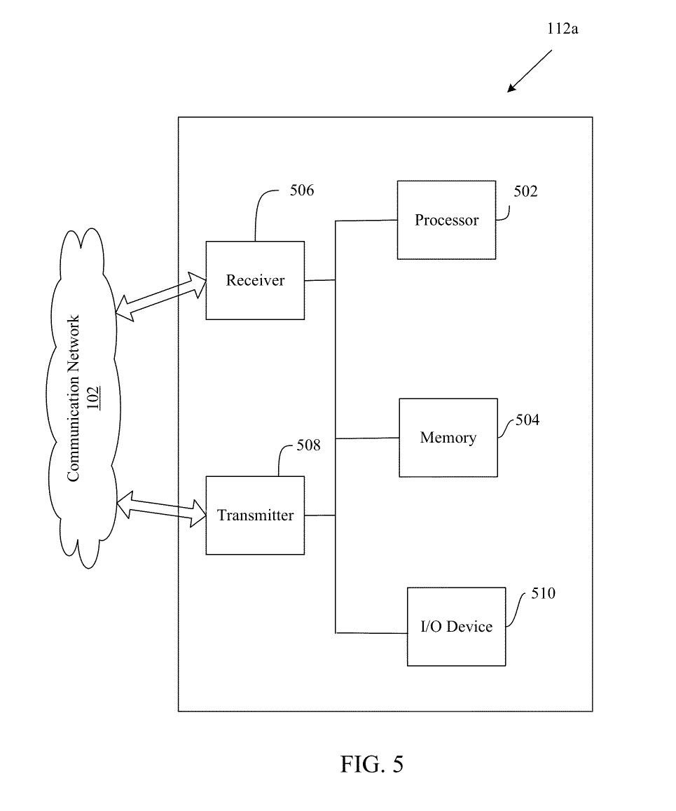

FIG. 5 is a block diagram of an exemplary user device for processing a real-time video stream, in accordance with an embodiment of the disclosure. The block diagram of FIG. 5 is described in conjunction with elements of FIG. 1 and FIG. 2.

With reference to FIG. 5, there is shown the first user device 112a. Although the user device shown in FIG. 5 corresponds to the first user device 112a, the disclosure is not so limited. A user device of FIG. 5 may also correspond to the second user device 112b and the third user device 112c, without limiting the scope of the disclosure.

The first user device 112a may comprise one or more processors, such as a processor 502, a memory 504, a receiver 506, a transmitter 508, and an input/output (I/O) device 510.

The processor 502 may be communicatively coupled to the memory 504, and the I/O device 510. The receiver 506 and the transmitter 508 may be communicatively coupled to the processor 502, the memory 504, and the I/O device 510.

The processor 502 may comprise suitable logic, circuitry, and/or interfaces that may be operable to execute at least one code section stored in the memory 504. The processor 502 may be implemented based on a number of processor technologies known in the art. Examples of the processor 502 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The memory 504 may comprise suitable logic, circuitry, interfaces, and/or code that may be operable to store a machine code and/or a computer program having at least one code section executable by the processor 502. Examples of implementation of the memory 504 may include, but are not limited to, Random Access Memory (RAM), Read Only Memory (ROM), Hard Disk Drive (HDD), and/or a Secure Digital (SD) card. The memory 504 may be operable to store data, such as configuration settings of the first user device 112a. The memory 504 may further be operable to store one or more parameters associated with a real-time video stream being broadcast by the server 110. The one or more parameters may comprise the geographic location at which a real-time video stream is to be broadcast. The one or more parameters may further comprise the language used by one or more users who will view a real-time video stream being broadcast. The memory 504 may further be operable to store one or more preferences of a user associated with the first user device 112a, and/or other information associated with the first user device 112a.

The receiver 506 may comprise suitable logic, circuitry, interfaces, and/or code that may be operable to receive data and messages. The receiver 506 may receive data in accordance with various known communication protocols. In an embodiment, the receiver 506 may receive real-time video stream broadcast by the server 110. The receiver 506 may implement known technologies for supporting wired or wireless communication between the server 110 and the first user device 112a.

The transmitter 508 may comprise suitable logic, circuitry, interfaces, and/or code that may be operable to transmit data and/or messages. The transmitter 508 may transmit data, in accordance with various known communication protocols. In an embodiment, the transmitter 508 may transmit a request to the server 110 to provide a real-time video stream to the first user device 112a.

The I/O device 510 may comprise various input and output devices that may be operably coupled to the processor 502. The I/O device 510 may comprise suitable logic, circuitry, interfaces, and/or code that may be operable to receive input from a user operating the first user device 112a and provide an output. Examples of input devices may include, but are not limited to, a keypad, a stylus, and/or a touch screen. Examples of output devices may include, but are not limited to, a display and/or a speaker.

In operation, the processor 502 may receive a real-time video stream from the server 110 via the transmitter 508. The processor 502 may process the received real-time video stream to identify the machine recognizable identifiers 108 in the received real-time video stream. Based on the machine recognizable identifiers 108, the processor 502 may identify one or more target areas on the objects 106 included in the real-time video stream. The processor 502 may determine the shape and/or the orientation of one or more target areas on the objects 106 included in the real-time video stream.

In an embodiment, the processor 502 may dynamically replace a first content in one or more of the target areas. In an embodiment, the processor 502 may determine the second content based on information associated with the machine recognizable identifiers 108. In an embodiment, the second content may be specified by the server 110. The processor 502 may display the real-time video stream with second content in one or more target areas.

In an embodiment, the processor 502 may modify a second content based on one or more parameters associated with one or more target areas. Examples of such one or more parameters may be the shape, the orientation, and/or the color of one or more target areas. In an embodiment, the processor 502 may modify a second content based on visibility of one or more of the machine recognizable identifiers 108, the one or more target areas and/or a first content of the one or more target areas. The processor 502 may modify second content in a manner as described above with regard to the processor 202 in FIG. 2.

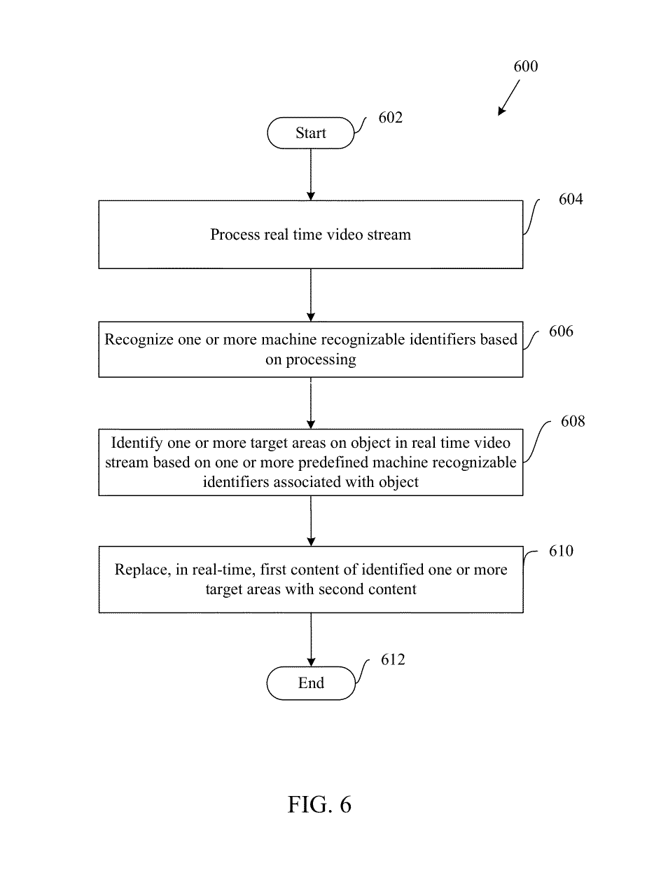

FIG. 6 is a flow chart illustrating exemplary steps for identifying target areas in a real-time video stream by a server, in accordance with an embodiment of the disclosure. With reference to FIG. 6, there is shown a flowchart 600. The flowchart 600 is described in conjunction with block diagram of FIG. 1 and FIG. 2.

The method starts at step 602 and proceeds to step 604. At step 604, a real-time video stream may be processed. At step 606, one or more machine recognizable identifiers may be identified in the real-time video stream. At step 608, one or more target areas may be identified on an object in the real-time video stream. The one or more target areas may be identified based on the one or more pre-defined machine recognizable identifiers. At step 610, a first content of the identified one or more target areas may be replaced, in real-time, with a second content. Control passes to end step 612.

In accordance with an embodiment of the disclosure, a network environment, such as the network environment 100 (FIG. 1), may comprise a network, such as the communication network 102 (FIG. 1). The network may be capable of communicatively coupling a one or more cameras 104 (FIG. 1), a server 110 (FIG. 1), and one or more user devices 112 (FIG. 1). The server 110 may comprise one or more processors, such as a processor 202 (FIG. 2). The one or more processors, such as the processor 202, may be operable to identify one or more target areas, such as target areas 302 (FIG. 3), on an object, such as the first object 106a (FIG. 1), in a real-time video stream. The one or more processors, such as the processor 202, may be operable to identify the one or more target areas 302 based on one or more pre-defined machine recognizable identifiers, such as the machine recognizable identifiers 108 (FIG. 1), associated with the object. The one or more processors, such as the processor 202, may be operable to replace, in real-time, a first content of the identified one or more target areas 302 with a second content.

The one or more processors, such as the processor 202, may be operable to process the real-time video stream to identify the one or more machine recognizable identifiers 108. The one or more processors, such as the processor 202, may be operable to broadcast the real-time video stream with the first content being replaced by the second content. The one or more processors, such as the processor 202, may be operable to determine a shape and/or an orientation of the one or more target areas 302. The one or more processors, such as the processor 202, may be operable to modify the second content based on the determined shape and/or the determined orientation.

The one or more processors, such as the processor 202, may be operable to select the second content based on one or more parameters associated with the real-time video stream. The one or more parameters may comprise geographic location at which the real-time video stream is to be broadcast or language used by one or more users viewing the real-time video stream. The one or more processors, such as the processor 202, may be operable to determine an obscured portion and a visible portion of the first content of the identified one or more target areas. The one or more processors, such as the processor 202, may be operable to modify the second content based on the obscured portion and the visible portion. The one or more processors, such as the processor 202, may be operable to replace, in real-time, the first content of the visible portion with the modified second content. The one or more processors, such as the processor 202, may be operable to crop a portion of the second content corresponding to the obscured portion. The one or more machine recognizable identifiers 108 may comprise one or more of: a Quick Response (QR) code, a bar code, a pre-defined color, a pre-defined shape, and/or a pre-defined pattern.

In accordance with an embodiment of the disclosure, a user device, such as the first user device 112a (FIG. 5) may comprise one or more processors, such as a processor 502 (FIG. 5). The one or more processors, such as the processor 502, may be operable to receive a real-time video stream from the server 110. The one or more processors, such as the processor 502, may be operable to identify one or more target areas, such as the target areas 302 (FIG. 3), on an object, such as the first object 106a (FIG. 1), in the real-time video stream. The one or more processors, such as the processor 502, may identify the one or more target areas 302 based on one or more pre-defined machine recognizable identifiers 108 associated with the object.

The one or more processors, such as the processor 502, may be operable to process the real-time video stream to identify the one or more machine recognizable identifiers 108. The one or more processors, such as the processor 502, may be operable to dynamically replace, in real-time, a first content of the identified one or more target areas 302 with a second content specified by the server 110.

The one or more processors, such as the processor 502, may be operable to display the real-time video stream with the first content being replaced by the second content. The one or more processors, such as the processor 502, may be operable to determine a shape and/or an orientation of the one or more target areas 302. The one or more processors, such as the processor 502, may be operable to modify the second content based on the determined shape and/or the determined orientation. The one or more processors, such as the processor 502, may be operable to determine an obscured portion and a visible portion of the identified one or more target areas. The one or more processors, such as the processor 502, may be operable to modify the second content based on the obscured portion and the visible portion. The one or more processors, such as the processor 502, may be operable to replace, in real-time, the first content of the visible portion with the modified second content. The one or more processors, such as the processor 502, may be operable to crop a portion of the second content corresponding to the obscured portion.

Various embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for identifying target areas in a real-time video stream. The at least one code section in a server may cause the machine and/or computer to perform the steps comprising identifying one or more target areas on an object in a real-time video stream based on one or more pre-defined machine recognizable identifiers associated with the object. The real-time video stream may be processed. One or more machine recognizable identifiers may be recognized based on the processing. A first content of the identified one or more target areas may be dynamically replaced with a second content. The real-time video stream with the first content being replaced by the second content may be broadcast. A shape and/or an orientation of the one or more target areas may be determined. The second content may be modified based on the determined shape and/or the determined orientation. The second content may be selected based on one or more parameters associated with the real-time video stream. The one or more parameters may comprise geographic location at which the real-time video stream is to be broadcast or language used by one or more users viewing the real-time video stream.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system comprising:
one or more processors in a server operable to:
identify one or more target areas on an object in a real-time video stream based on one or more pre-defined machine recognizable identifiers associated with said object; and
replace, in real-time, a first content of said identified one or more target areas with a second content.

2. The system of claim 1, wherein said one or more processors are operable to process said real-time video stream to identify said one or more machine recognizable identifiers.

3. The system of claim 1, wherein said one or more processors are operable to broadcast said real-time video stream with said first content being replaced by said second content.

4. The system of claim 1, wherein said one or more processors are operable to:
determine a shape and/or an orientation of said one or more target areas; and
modify said second content based on said determined shape and/or said determined orientation.

5. The system of claim 1, wherein said one or more processors are operable to select said second content based on one or more parameters associated with said real-time video stream.

6. The system of claim 5, wherein said one or more parameters comprise geographic location at which said real-time video stream is to be broadcast or language used by one or more users viewing said real-time video stream.

7. The system of claim 1, wherein said one or more processors are operable to:
determine an obscured portion and a visible portion of said first content of said identified one or more target areas;
modify said second content based on said obscured portion and said visible portion; and
replace, in real-time, said first content of said visible portion with said modified second content.

8. The system of claim 7, wherein said one or more processors are operable to crop a portion of said second content corresponding to said obscured portion.

9. The system of claim 1, wherein said one or more machine recognizable identifiers comprise one or more of: a Quick Response (QR) code, a bar code, a pre-defined color, a pre-defined shape, and/or a pre-defined pattern.

10. A method comprising:
in a server:
identifying one or more target areas on an object in a real-time video stream based on one or more pre-defined machine recognizable identifiers associated with said object; and
replacing, in real-time, a first content of said identified one or more target areas with a second content.

11. The method of claim 10, further comprising:
processing said real-time video stream; and
recognizing said one or more machine recognizable identifiers based on said processing.

12. The method of claim 10, further comprising broadcasting said real-time video stream with said first content being replaced by said second content.

13. The method of claim 10, further comprising:
determining a shape and/or an orientation of said one or more target areas; and
modifying said second content based on said determined shape and/or said determined orientation.

14. The method of claim 10, further comprising selecting said second content based on one or more parameters associated with said real-time video stream.

15. The method of claim 14, wherein said one or more parameters comprise a geographic location at which said real-time video stream is to be broadcast or language used by one or more users viewing said real-time video stream.

16. A system comprising:
one or more processors in a user device operable to:
receive a real-time video stream from a server; and
identify one or more target areas on an object in said real-time video stream based on one or more pre-defined machine recognizable identifiers associated with said object.

17. The system of claim 16, wherein said one or more processors are operable to process said real-time video stream to identify said one or more machine recognizable identifiers.

18. The system of claim 16, wherein said one or more processors are operable to dynamically replace, in real-time, a first content of said identified one or more target areas with a second content specified by said server.

19. The system of claim 18, wherein said one or more processors are operable to display said real-time video stream with said first content being replaced by said second content.

20. The system of claim 18, wherein said one or more processors are operable to:
determine a shape and/or an orientation of said one or more target areas; and
modify said second content based on said determined shape and/or said determined orientation.

21. The system of claim 18, wherein said one or more processors are operable to:
determine an obscured portion and a visible portion of said identified one or more target areas;
modify said second content based on said obscured portion and said visible portion; and
replace, in real-time, said first content of said visible portion with said modified second content.

22. The system of claim 21, wherein said one or more processors are operable to crop a portion of said second content corresponding to said obscured portion.
